(19) United States
(12) Patent Application Publication
(10) Pub. No.: US 2019/0345736 A1
(43) Pub. Date: Nov. 14, 2019

(54) GARAGE DOOR LOCK SYSTEM

(71) Applicant: Kenneth Woodworth, St. Johns, FL (US)

(72) Inventor: Kenneth Woodworth, St. Johns, FL (US)

(21) Appl. No.: 15/977,719

(22) Filed: May 11, 2018

(51) Int. Cl. E05B 47/00; E05B 45/06

(52) U.S. Cl. CPC E05B 47/0004; E05B 45/06; E05B 2045/063; E05B 2047/0016; E05B 2047/0071; E05Y 2900/106

(57) ABSTRACT

A garage door lock system is a security system for garage doors having two solenoids mounted to the roller tracks of the garage door which when activated extends a bar or rod through the rails to prevent the rollers at the edges of the garage door from traversing the rails. The system also includes a control unit, camera, motion sensors, and radio frequency transreceivers.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of door locks and more specifically relates to a garage door lock system.

### 2. Description of the Related Art

Burglaries occur every day somewhere, especially in more densely populated areas. These types of invasions account for the largest category of calls to police. Burglars often look for an open window or door to enter but will break a window or will kick or pry a door open when there is no open window or door. Most often, experienced burglars watch a residence to see a pattern for when the owner leaves from and returns to the home, and when they are relatively certain they won't get caught, they strike. One area of weakness that most homes have is the garage door. Homeowners will often leave the residence to go somewhere such as shopping for a short duration and then return home a short time later to find they have been burglarized. Many times homeowners think that they will only be gone for a short time and that it will be safe to just close the door without locking it. This is done more often than not because of the extra inconvenience of constantly locking and unlocking the door when leaving frequently. The automatic door opener will lock the door to some extent but the weakest components are plastic or nylon which is easily broken when a pry bar is used to pry the door up. This much is avoidable by taking the time to lock the door and unlock it each time when leaving and returning, but this is an inconvenience that will not likely cause homeowners to change their habits. An automatically operating solution is needed.

Various attempts have been made to solve the above-mentioned problems but lack convenience or security. Ideally, a garage door lock should provide automation and secure locking, and yet, would operate reliably and be manufactured at a modest expense. Thus, a need exists for a reliable garage door lock system to avoid the above-mentioned problems.

### BRIEF SUMMARY OF THE INVENTION

In view of the foregoing disadvantages inherent in the known door lock art, the present invention provides a novel garage door lock system. The general purpose of the present invention, which will be described subsequently in greater detail, is to provide the convenience of automation with secure locking.

A garage door lock system preferably comprises a control unit adapted to be located in proximity to an overhead garage door opener that includes a transceiver that is adapted to send and receive electronic signals, a circuit card that is adapted to control the control unit and allow wireless remote access, an antenna adapted to transmit or receive electronic signals to and from the transceiver, and a pair of solenoid locking members each including a locking bar, a spring adapted to move the locking bar, and a solenoid that controls the movement of the spring and to receive electronic signals from the transceiver of the control unit to move the locking bar into locked and opened positions.

The pair of solenoid locking members are adapted to be attached to respective garage door rails of a garage door mechanism to selectively block roller members of the garage door mechanism via the locking bars from traversing the garage door rails. A power source is connected to and adapted to supply power to the control unit and to the pair of solenoid locking members via electric wires.

Each solenoid includes a micro switch that having a transceiver adapted to send and receive electronic signals wirelessly to control movement of its respective locking bar. Electric wires are respectively connected between each solenoid and the transceiver of the control unit to control movement of respective locking bars. Each solenoid further includes a manual latching pin connected to its respective locking bar and adapted to allow manual movement of the locking bar into an open position during power failures.

A remote control unit that can be carried by a user for controlling the garage door mechanism and the control unit is adapted to turn on and turn off power from the power source to the control unit. Two garage door floor sensors are electronically connected to the control unit and adapted to be attached to respective garage door rails of the garage door mechanism in proximity to a garage floor and adapted to detect movement into and out of the garage. The control unit is also adapted to communicate with a home security monitoring system so that when the solenoids are activated, the control unit sends a signal to the home security monitoring system to notify the home owner of garage door mechanism activity. The control unit further includes a motion sensor and a camera adapted to activate and record images of the area surrounding the control unit when motion is detected by the motion detector. The control unit further includes an LED adapted to activate when the motion detector detects motion and activates the camera to record images of the area surrounding the control unit.

The transceiver of the control unit and the transceivers of the micro switches send and receive electronic signals using BLUETOOTH technology and send and receive electronic signals using WIFI technology and/or WLAN technology. The control unit further includes a timing mechanism controlled by the circuit card that is adapted to provide a time delay between when the solenoid moves the locking bar into an opened position and then into a closed position.

The combination of a garage door, a garage door mechanism, and a garage door lock system preferably comprises a garage door having at least one garage door panel and at least two roller members movably attached to opposite sides of the garage door that are adapted to traverse respective track members of a garage door mechanism to aid in the movement of the garage door panels, a garage door mechanism including two spaced garage door rails adapted to be attached to opposite sides of a garage door opening and adapted to movably receive at least two roller members for each garage door rail, an overhead garage door opener having a motor member adapted to be attached to a ceiling portion of a garage, a track member that is adapted to be attached to a ceiling portion of the garage adjacent the motor member, and a movable connector member mechanically connected to the motor member and adapted move along the track member that is connected to the garage door.

The overhead garage door opener is adapted to open and close the garage door with respect to the garage door opening. The garage door lock system comprises a control unit including a transceiver adapted to send and receive electronic signals, a circuit card that is adapted to control the control unit and allow wireless remote access, and an antenna adapted to transmit and receive electronic signals to and from the transceiver. The control unit is adapted to be located in proximity to the overhead garage door opener.

A pair of solenoid locking members each include a locking bar and spring adapted to move the locking bars. A solenoid controls the movement of the spring and is adapted to receive electronic signals from the transceiver of the control unit to move the locking bar into locked and opened positions. The pair of solenoid locking members is adapted to be attached respectively to each spaced garage door rail of the garage door mechanism and selectively block the roller members of the garage door via the locking bars from traversing the garage door rails.

A power source is connected to and adapted to supply power to the motor member of the overhead garage door opener, the control unit, and to the pair of solenoid locking members via electric wires. Each solenoid includes a micro switch that has a transceiver adapted to send and receive electronic signals wirelessly to control movement of its respective locking bar. The solenoids further include a manual latching pin connected to its respective locking bar adapted to allow manual movement of the locking bar into an open position during power failures.

A remote control unit is adapted to be carried by a user and adapted to control the garage door mechanism and the control unit and to turn on and turn off power from the power source to the control unit. Two garage door floor sensors are electronically connected to the control unit and adapted to be attached to respective garage door rails of the garage door mechanism in proximity to a garage floor and adapted to detect movement into and out of a garage. The control unit is adapted to communicate with a home security monitoring system such that when the solenoids are activated the control unit sends a signal to the home security monitoring system to notify the home owner of the garage door mechanism activity. The control unit further includes a motion sensor and a camera adapted to activate and record images of the area surrounding the control unit when motion is detected by the motion detector and includes an LED adapted to activate when the motion detector detects motion and activates the camera to record images of the area surrounding the control unit. The control unit further includes a timing mechanism controlled by the circuit card that is adapted to provide a time delay between when the solenoid moves the locking bar into an opened position and then into a closed position.

The present invention holds significant improvements and serves as a garage door lock system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, garage door lock system, constructed and operative according to the teachings of the present invention.

FIG. 1 shows an in-use condition illustrating a garage door lock system according to an embodiment of the present invention.

FIG. 2 is a side view illustrating a combination of a garage door, a garage door mechanism, and a garage door lock system according to an embodiment of the present invention of FIG. 1.

FIG. 3 is a perspective view illustrating a solenoid locking member garage door lock system according to an embodiment of the present invention of FIG. 1.

FIG. 4 is a diagram illustrating garage door lock system according to an embodiment of the present invention of FIG. 1.

FIG. 5 is a flowchart illustrating a method of operation for the garage door lock system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a door lock and more particularly to a garage door lock system as used to improve convenience with automation and secure locking.

Generally speaking, the garage door lock system is a security system for garage doors having two solenoids mounted to the roller tracks of the garage door which when activated extends a bar or rod through the rails to prevent the rollers at the edges of the garage door from traversing the rails. The system also includes a control unit, camera, motion sensors, and radio frequency transreceivers.

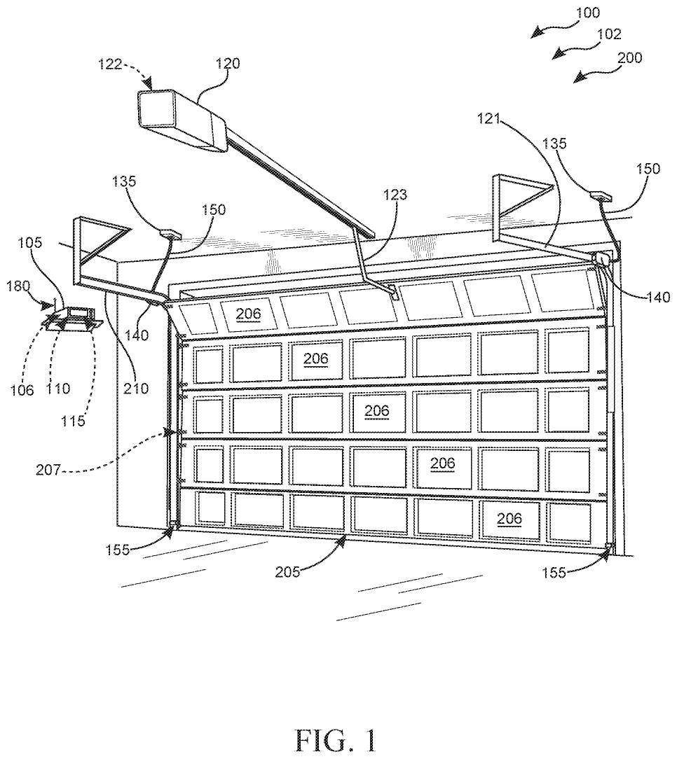

Referring to the drawings by numerals of reference there is shown in FIG. 1, an in-use condition illustrating garage door lock system 100 according to an embodiment of the present invention.

Garage door lock system 100 preferably comprises control unit 105 adapted to be located in proximity to overhead garage door opener 120 that includes transceiver 110 that is adapted to send and receive electronic signals, circuit card 115 that is adapted to control control unit 105 and allow wireless remote access, antenna 180 adapted to transmit or receive electronic signals to and from transceiver 110, and a pair of solenoid locking member(s) 130 each including locking bar 131, spring 132 adapted to move locking bar 131, and solenoid 140 that controls the movement of spring 132 and to receive electronic signals from transceiver 110 of control unit 105 to move locking bar 131 into locked and opened positions.

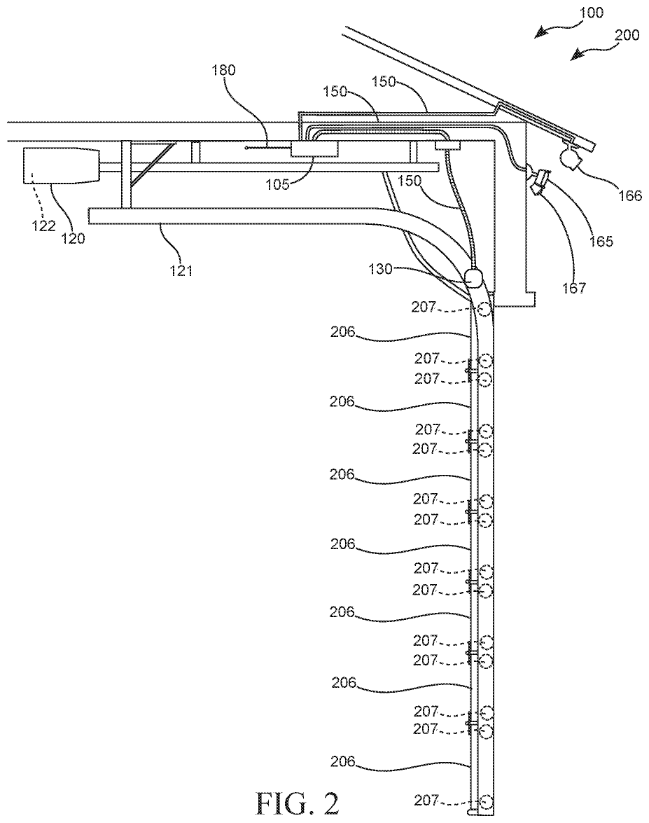

Referring now to FIG. 2, is a side view illustrating combination of a garage door, a garage door mechanism, and a garage door lock system 200 according to an embodiment of the present invention of FIG. 1.

Combination of a garage door, a garage door mechanism, and a garage door lock system 200 preferably comprises garage door 205 having at least one garage door panel 206 and at least two roller members 207 movably attached to opposite sides of garage door 205 that are adapted to traverse respective garage door rail(s) 121 of garage door mechanism 102 to aid in the movement of garage door panel(s) 206, garage door mechanism 102 including two spaced garage door rail(s) 121 adapted to be attached to opposite sides of a garage door opening and adapted to movably receive at least two roller member(s) 207 for each garage door rail(s) 121, overhead garage door opener 120 having motor member 122 adapted to be attached to a ceiling portion of a garage, track member 210 that is adapted to be attached to a ceiling portion of the garage adjacent motor member 122, and movable connector member 123 mechanically connected to motor member 122 and adapted move along track member 210 that is connected to garage door 205.

Overhead garage door opener 120 is adapted to open and close garage door 205 with respect to the garage door opening. Garage door lock system 100 comprises control unit 105 including transceiver 110 adapted to send and receive electronic signals, circuit card 115 that is adapted to operate control unit 105 and allow wireless remote access, and antenna 180 adapted to transmit and receive electronic signals to and from transceiver 110. Control unit 105 is adapted to be located in proximity to overhead garage door opener 120.

A pair of solenoid locking member(s) 130 each includes locking bar 131 and spring 132 adapted to move locking bar(s) 131. Solenoid 140 controls the movement of spring 132 and is adapted to receive electronic signals from transceiver 110 of control unit 105 to move locking bar(s) 131 into locked and opened positions. The pair of solenoid locking member(s) 130 is adapted to be attached respectively to each spaced garage door rail(s) 121 of garage door mechanism 102 and selectively block roller member(s) 207 of garage door 205 via locking bar(s) 131 from traversing garage door rail(s) 121.

Power source 135 is connected to and adapted to supply power to motor member 122 of overhead garage door opener 120, control unit 105, and to the pair of solenoid locking member(s) 130 via electric wires 150. Each solenoid 140 includes micro switch 141 that has transceiver 142 adapted to send and receive electronic signals wirelessly to control movement of its respective locking bar(s) 131. Solenoids 140 further include manual latching pin 133 connected to its respective locking bar(s) 131 adapted to allow manual movement of locking bar(s) 131 into an open position during power failures.

Remote control unit 145 is adapted to be carried by a user and adapted to control garage door mechanism 102 and control unit 105 and to turn on and turn off power from the power source 135 to control unit 105. Two garage door floor sensors 155 are electronically connected to control unit 105 and adapted to be attached to respective garage door rail(s) 121 of garage door mechanism 102 in proximity to a garage floor and adapted to detect movement into and out of a garage. Control unit 105 is adapted to communicate with home security monitoring system 160 such that when solenoid(s) 140 are activated control unit 105 sends a signal to home security monitoring system 160 to notify the home owner of garage door mechanism 102 activity. Control unit 105 further includes motion sensor 165 and camera 166 adapted to activate and record images of the area surrounding control unit 105 when motion is detected by motion sensor 165 and includes led 167 adapted to activate when motion sensor 165 detects motion and activates camera 166 to record images of the area surrounding control unit 105. Control unit 105 further includes timing mechanism 106 controlled by circuit card 115 that is adapted to provide a time delay between when solenoid(s) 140 moves locking bar(s) 131 into an opened position and then into a closed position.

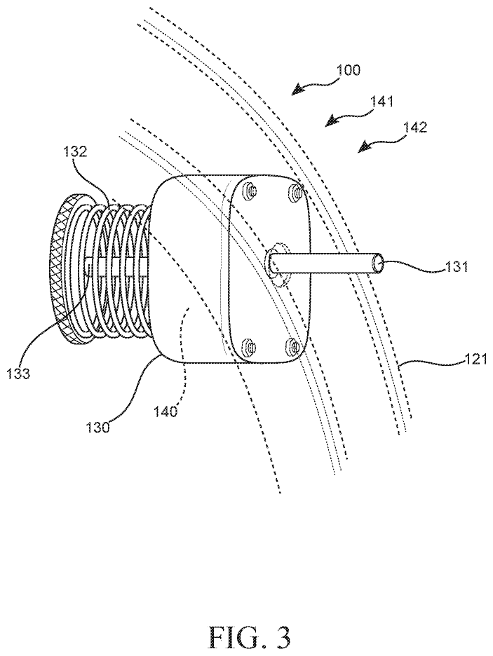

Referring now to FIG. 3, is a perspective view illustrating solenoid locking member 130 of garage door lock system 100 according to an embodiment of the present invention of FIG. 1.

The pair of solenoid locking member(s) 130 is adapted to be attached to respective garage door rail(s) 121 of garage door mechanism 102 to selectively block roller member(s) 207 of garage door mechanism 102 via locking bar(s) 131 from traversing garage door rail(s) 121. Power source 135 is connected to and adapted to supply power to control unit 105 and to the pair of solenoid locking member(s) 130 via electric wires 150.

Each solenoid(s) 140 includes micro switch 141 that having transceiver 142 adapted to send and receive electronic signals wirelessly to control movement of its respective locking bar(s) 131. Electric wires 150 are respectively connected between each solenoid(s) 140 and transceiver 110 of control unit 105 to control movement of respective locking bar(s) 131. Each solenoid(s) 140 further includes manual latching pin 133 connected to its respective locking bar(s) 131 and adapted to allow manual movement of locking bar(s) 131 into an open position during power failures.

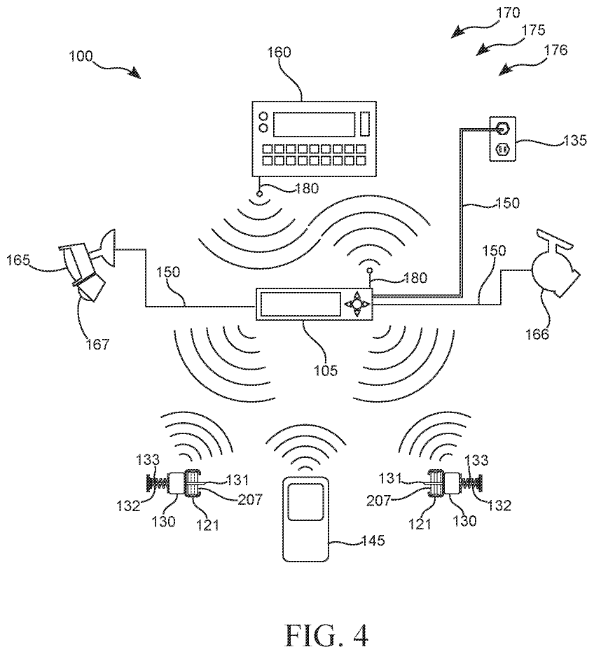

Referring now to FIG. 4, is a diagram illustrating garage door lock system 100 according to an embodiment of the present invention of FIG. 1.

Remote control unit 145 that can be carried by a user for controlling garage door mechanism 102 and control unit 105 is adapted to turn on and turn off power from power source 135 to control unit 105. Two garage door floor sensors 155 are electronically connected to control unit 105 and adapted to be attached to respective garage door rail(s) 121 of garage door mechanism 102 in proximity to a garage floor and adapted to detect movement into and out of the garage. Control unit 105 is also adapted to communicate with home security monitoring system 160 so that when solenoid(s) 140 are activated, control unit 105 sends a signal to home security monitoring system 160 to notify the home owner of garage door mechanism 102 activity. Control unit 105 further includes motion sensor 165 and camera 166 adapted to activate and record images of the area surrounding control unit 105 when motion is detected by motion sensor 165. Control unit 105 further includes led 167 adapted to activate when motion sensor 165 detects motion and activates camera 166 to record images of the area surrounding control unit 105.

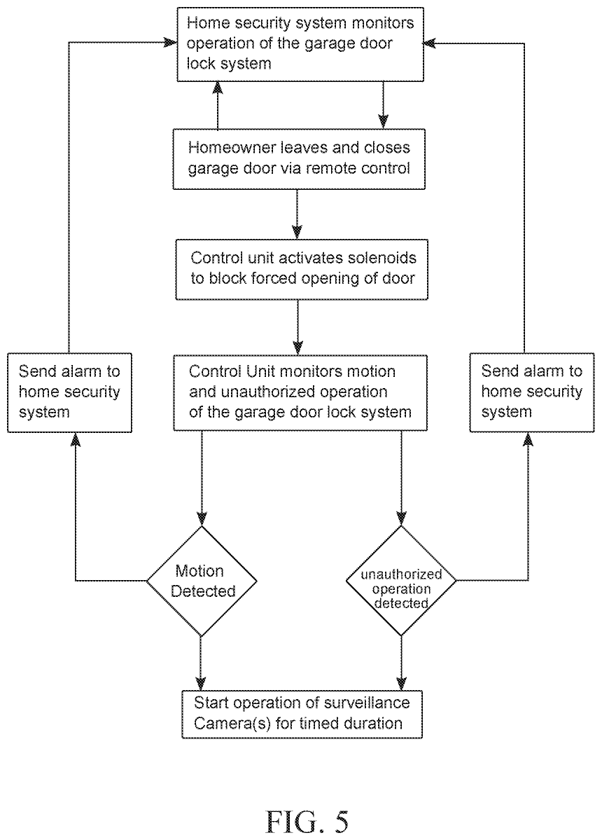

Referring now to FIG. 5, is a flowchart illustrating a method of operation for garage door lock system 100 according to an embodiment of the present invention of FIGS. 1-4.

Transceiver 110 of control unit 105 and transceiver(s) 142 of micro switch 141 send and receive electronic signals using BLUETOOTH technology 170 and send and receive electronic signals using WIFI technology 175 and/or WLAN technology 176. Control unit 105 further includes a timing mechanism controlled by circuit card 115 that is adapted to provide a time delay between when solenoid(s) 140 moves locking bar(s) 131 into an opened position and then into a closed position.

Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

Garage door lock system 100 may be manufactured and provided for sale in a wide variety of sizes and shapes for a wide assortment of applications. It should be noted that the method of operation can be carried out in many different orders according to user preference or programmable to account for unpredictable circumstances and as such is not intended to invoke the provisions of 35 U.S.C. § 112, ¶116. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A garage door lock system comprising:
a control unit including:
a transceiver;
wherein said transceiver is adapted to send and receive electronic signals;
a circuit card;
wherein said circuit card is adapted to control said control unit and allow wireless remote access;
an antenna;
wherein said antenna is adapted to transmit or receive electronic signals to and from said transceiver;
wherein said control unit is adapted to be located in proximity to an overhead garage door opener;
a pair of solenoid locking members, each including:
a locking bar;
a spring;
wherein said spring is adapted to move said locking bar; and
a solenoid;
wherein said solenoid controls the movement of said spring; and
wherein said solenoid is adapted to receive electronic signals from said transceiver of said control unit to move said locking bar into locked and opened positions;
wherein said pair of solenoid locking members are adapted to be attached to respective garage door rails of a garage door mechanism and selectively block roller members of said garage door mechanism via said locking bars from traversing respective said garage door rails; and
a power source;
wherein said power source is connected to and adapted to supply power to said control unit and to said pair of solenoid locking members via electric wires.

2. The garage door lock system of claim 1, wherein each said solenoid includes a micro switch that includes a transceiver adapted to send and receive electronic signals wirelessly to control movement of its respective said locking bar.

3. The garage door lock system of claim 1, further comprising electric wires respectively connected between each said solenoid and said transceiver of said control unit to control movement of respective said locking bars.

4. The garage door lock system of claim 1, wherein each said solenoid further includes a manual latching pin connected to its respective said locking bar and adapted to allow manual movement of said locking bar into an open position during power failures.

5. The garage door lock system of claim 1, further comprising a remote control unit adapted to be carried by a user and adapted to control said garage door mechanism and said control unit;
and wherein said remote control unit is adapted to turn on and turn off power from said power source to said control unit.

6. The garage door lock system of claim 1, further comprising two garage door floor sensors electronically connected to said control unit and adapted to be attached to respective said garage door rails of said garage door mechanism in proximity to a garage floor and adapted to detect movement into and out of a garage.

7. The garage door lock system of claim 1, wherein said control unit is adapted to communicate with a home security monitoring system, such that when said solenoids are activated said control unit sends a signal to said home security monitoring system to notify a home owner of garage door mechanism activity.

8. The garage door lock system of claim 1, wherein said control unit further includes a motion sensor and a camera adapted to activate and record images of the area surrounding said control unit when motion is detected by said motion detector.

9. The garage door lock system of claim 2, wherein said transceiver of said control unit and said transceivers of said micro switches send and receive electronic signal using BLUETOOTH technology.

10. The garage door lock system of claim 2, wherein said transceiver of said control unit and said transceivers of said micro switches send and receive electronic signal using WWI technology.

11. The garage door lock system of claim 2, wherein said transceiver of said control unit and said transceivers of said micro switches send and receive electronic signal using WLAN technology.

12. The garage door lock system of claim 8, wherein said control unit further includes an LED adapted to activate when said motion detector detects motion and activates said camera to record images of said area surrounding said control unit.

13. The garage door lock system of claim 1, wherein said control unit further includes a timing mechanism controlled by said circuit card that is adapted to provide a time delay between when said solenoid moves said locking bar into an opened position and then into a closed position.

14. A combination of a garage door, a garage door mechanism, and a garage door lock system, said combination comprising:
a garage door including:
at least one garage door panel; and
at least two roller members movably attached to opposite sides of said garage door and adapted to traverse respective track members of a garage door mechanism to aid in the movement of said at least one garage door panel;
a garage door mechanism including:
two spaced garage door rails adapted to be attached to opposite sides of a garage door opening and adapted to movably receive respective said at least two roller members;
an overhead garage door opener including:
a motor member
wherein said motor member is adapted to be attached to a ceiling portion of a garage;
a track member;
wherein said track member is adapted to be attached to a ceiling portion of said garage adjacent said motor member;
a movable connector member;
wherein said movable connector member is mechanically connected to said motor member, is adapted move along said track member, and is connected to said garage door;
wherein said overhead garage door opener is adapted to open and close said garage door with respect to said garage door opening; and
a garage door lock system comprising:
a control unit including:
a transceiver;
wherein said transceiver is adapted to send and receive electronic signals;
a circuit card;
wherein said circuit card is adapted to control said control unit and allow wireless remote access;
an antenna;
wherein said antenna is adapted to transmit or receive electronic signals to and from said transceiver;
wherein said control unit is adapted to be located in proximity to said overhead garage door opener;
a pair of solenoid locking members, each including:
a locking bar;
a spring;
wherein said spring is adapted to move said locking bar; and
a solenoid;
wherein said solenoid controls the movement of said spring; and
wherein said solenoid is adapted to receive electronic signals from said transceiver of said control unit to move said locking bar into locked and opened positions;
wherein said pair of solenoid locking members are adapted to be attached to respective said two spaced garage door rails of said garage door mechanism and selectively block said at least two roller members of said garage door via said locking bars from traversing respective said two spaced garage door rails; and
a power source;
wherein said power source is connected to and adapted to supply power to said motor member of said overhead garage door opener, said control unit, and to said pair of solenoid locking members via electric wires.

15. The combination of claim 14, wherein each said solenoid includes a micro switch that includes a transceiver adapted to send and receive electronic signals wirelessly to control movement of its respective said locking bar.

16. The combination of claim 14, wherein each said solenoid further includes a manual latching pin connected to its respective said locking bar and adapted to allow manual movement of said locking bar into an open position during power failures.

17. The combination of claim 14, further comprising a remote control unit adapted to be carried by a user and adapted to control said garage door mechanism and said control unit; and
wherein said remote control unit is adapted to turn on and turn off power from said power source to said control unit.

18. The combination of claim 14, further comprising two garage door floor sensors electronically connected to said control unit and adapted to be attached to respective said garage door rails of said garage door mechanism in proximity to a garage floor and adapted to detect movement into and out of a garage.

19. The combination of claim 14, wherein said control unit is adapted to communicate with a home security monitoring system, such that when said solenoids are activated said control unit sends a signal to said home security monitoring system to notify a home owner of garage door mechanism activity.

20. The combination of claim 14, wherein said control unit further includes a motion sensor and a camera adapted to activate and record images of the area surrounding said control unit when motion is detected by said motion detector; wherein said control unit further includes an LED adapted to activate when said motion detector detects motion and activates said camera to record images of said area surrounding said control unit; and
wherein said control unit further includes a timing mechanism controlled by said circuit card that is adapted to provide a time delay between when said solenoid moves said locking bar into an opened position and then into a closed position.
